(19) United States
(12) Patent Application Publication
(10) Pub. No.: US 2009/0178121 A1
(43) Pub. Date: Jul. 9, 2009

(54) Method For Restricting Access To Data Of Group Members And Group Management Computers

(75) Inventor: Karsten Lüttge, Berlin (DE)

Correspondence Address: K&L Gates LLP, P.O. BOX 1135, CHICAGO, IL, 60690, US

(73) Assignee: NOKIA SIEMENS NETWORKS GMBH & CO., München (DE)

(21) Appl. No.: 12/297,825

(22) PCT Filed: Apr. 18, 2007
(86) PCT No.: PCT/EP2007/053794

§ 371 Date: Feb. 19, 2009

(30) Foreign Application Priority Data
Apr. 18, 2006 (DE) 10 2006 018 889.6

(51) Int. Cl. H04L 9/32; G06F 12/14

(52) U.S. Cl. 726/4; 726/28

(57) ABSTRACT

The invention relates to a method for restricting the access to data of group members of a service subscriber group. Group members of a service subscriber group are each assigned an identifier. The data of the group members are assigned to the identifier in each case and the data of the group members are stored in a data memory (DS2) of a group management computer (GR) which manages the service subscriber group. Applying the method, a first group member requests a service, providing the identifier of a second group member, the performance of said service requiring the data of the second group member. The identifier of the second group member is sent to the group management computer, which verifies whether the requested service using the data of the second group member is authorized, and in the case where an authorization exists the data of the second group member are sent to a service computer (DR1) controlling the performance of the requested service. The invention also relates to a group management computer

A method for restricting access to data of group members and group management computers

The invention relates to a method for restricting the access to data of group members of a service subscriber group and a group management computer.

The utilization of service subscriber groups (also called communities) is increasingly gaining in importance in mobile and wire-connected communication networks. Such service subscriber groups are groups of subscribers to a service which is offered by utilizing a communication network. Such service subscriber groups comprise, for example, subscribers which are interested in certain fields of subjects (e.g. subscribers to a web forum www.cabrionews.de). Such service subscriber groups can also be used, for example, as so-called “buddy lists”, as subscriber groups in chat rooms with instant messaging services, as groups of registered users in on-line games or as groups in push-to-talk services. Carrying out services often requires data of the group members of the service subscriber group. Such data can be, in particular, addressing data or information, for example a telephone number, an instant messaging address or also an account number of a group member of the service subscriber group. Such person-related data are often of a private nature and the group members of the service subscriber group are often critical of the forwarding of these data.

The invention is based on the object of specifying a method and a group management computer by means of which the access to data of group members of a service subscriber group can be restricted.

According to the invention, this object is achieved by a method for restricting the access to (person-related) data of group members of a service subscriber group in which an identifier is in each case allocated to group members of a service subscriber group (which is unambiguous within the service subscriber group), the data of the group members are in each case allocated to the identifier and the data of the group members are stored in a data memory of a group management computer which manages the service subscriber group, wherein, in the method, a first group member, specifying the identifier of a second group member, the execution of which requests a service, the data of the second group member requires, the identifier of the second group member is transmitted to the group management computer, whether the requested service is authorized a check is made to utilize the data of the second group member, when an authorization is present, the data of the second group member are transferred to a service computer controlling the execution of the requested service, whereupon the service can be executed by utilizing the data (e.g. the service-specific addressing data or information).

In this context, it is particularly advantageous that the first group member (and the other group members of the service subscriber group) only need to know the identifier of the second group member. The person-related private data of the second group member himself are not known to the first group member and the other group members of the service subscriber group, however, and are not made known to these, either, during the entire method. Once the service has been requested from the first group member by specifying the identifier, a check is made whether the requested service is authorized for utilizing the data of the second group member. If the service is authorized for utilizing the data of the second group member, that is to say, if a corresponding authorization is present, the data of the second group member are transmitted to the service-controlling service computer, but not to the first group member or to other group members of the service subscriber group. The service can then be carried out by utilizing the data without the data of the second group member becoming known to the first group member or other group members. A transfer of the data of the second member to the first group member or to other group members of the service subscriber group is thus avoided and the access to the data of the second group member is restricted to the service computer which controls the requested service. This is advantageous, in particular, because the second group member can control the future access to his data by means of his identifier. If the second group member wishes to prevent for the future that services are carried out for which his data are needed, the second group member can prevent or restrict the execution of such services, for example by changing or deleting his identifier or by changing or deleting his data.

Thus, communication services between group members of a service subscriber group are advantageously made possible without a group member needing to know the person-related data of the respective other group members.

The method can be arranged in such a manner that the service subscriber group is set up for utilizing several different services. In this context, the (one) allocated identifier and the allocated data of the second group member can be advantageously used in the utilization of different services. It is thus not necessary to set up or allocate a separate identifier and separate data for each individual service.

The method can proceed in such a manner that (in dependence on the requested service), from the data of the second group member those data are selected which are needed for executing the requested service, and (only) the selected data are transferred to the service computer. In this context, it is advantageous that only the data needed for the execution of the respective requested service are transferred to the service computer. Only the data relating to the second group member are thus transferred to the service computer, which are absolutely needed for executing the respective service. This also meets the interest of data protection of the second service user.

The method can proceed in such a manner that (in dependence on the requested service), from a multiplicity of service computers the service computer controlling the requested service is selected, and the data of the second group member are transferred to the selected service computer. This ensures that the data needed for the respective service are only transferred to the service computer which controls the requested service and not to other service computers controlling other services. This, too, restricts the access to the data of the second group member.

The method can proceed in such a manner that a telephony service, a message transmission service or an on-line payment service is requested as service.

In this context, the method can be arranged in such a manner that in the case of a telephony service, the data of the second group member comprise a telephone number of the second group member, in the case of a message transmission service, the data of the second group member comprise a message address of the second group member or in the case of an on-line payment service, the data of the second group member comprise an account number of the second group member.

The method can also proceed in such a manner that the data of the second group member are kept available by the group management computer in such a manner that various service-controlling service computers can access the data and/or that the data can be transferred to various service-controlling service computers. In this arrangement, a single group management computer advantageously supports different service-controlling service computers, and thus the execution of different services. This makes it possible to manage subscriber groups for different services in a simple and very comfortable manner.

Furthermore, the method can proceed in such a manner that several identifiers are allocated to a group member of a service subscriber group (service subscriber), wherein the same data are allocated to these several identifiers or to each of these several identifiers, in each case other data (e.g. different records: business data, private data) are allocated. In particular, an embodiment is possible in such a manner that a service subscriber is assigned for each service subscriber group in which he is a member, a separate identifier which is only valid and visible within this group. As a result, the service subscriber can control in detail his availability for other service subscribers - e.g. he can terminate the contact to a service subscriber group by deleting the identifier valid in this group, i.e. by deleting the identifier by which he is known in this group. Members of other groups can still communicate with the service subscriber by utilizing the identifier valid and known in the other groups.

The above-mentioned object is also achieved by a group management computer which is arranged for receiving an identifier of a group member of a service subscriber group, for receiving information about a service for the execution of which (person-related) data of the group member are needed, for checking whether the service is authorized to use the data of the group member, and for transmitting the data of the group member to a service computer controlling the execution of the service.

The group management computer can be arranged for selecting those data from the data of the group member which are needed for executing the service, and for transferring the selected data to the service computer. The selecting is carried out by means of the received information about the service.

The group management computer can be arranged for selecting a service computer from a multiplicity of service computers by means of the received information about the service, and for transferring the data to the selected service computer.

The group management computer can also be arranged for transferring a telephone number of the group member to the service computer controlling the execution of the service if the service is a telephony service, transferring a message address of the group member to the service computer controlling the execution of the service if the service is a message transmission service, and/or transferring an account number of the group member to the service computer controlling the execution of the service if the service is an on-line payment service.

The group management computer can be preferably arranged for enabling various service-controlling service computers to access the data of the group member and/or transferring the data of the group member to various service-controlling service computers.

The group management computer can have an interface for setting up, changing and/or deleting service subscriber groups.

The group management computer can have an interface for inputting, altering and/or deleting identifiers of group members, have an interface for inputting, altering and/or deleting data of group members and/or have an interface for communicating with at least one service-controlling service computer.

The advantages of the group management computer according to the invention correspond to the advantages mentioned above in conjunction with the method for restricting the access.

In the text which follows, the invention will be explained in greater detail with reference to exemplary embodiments, in which,

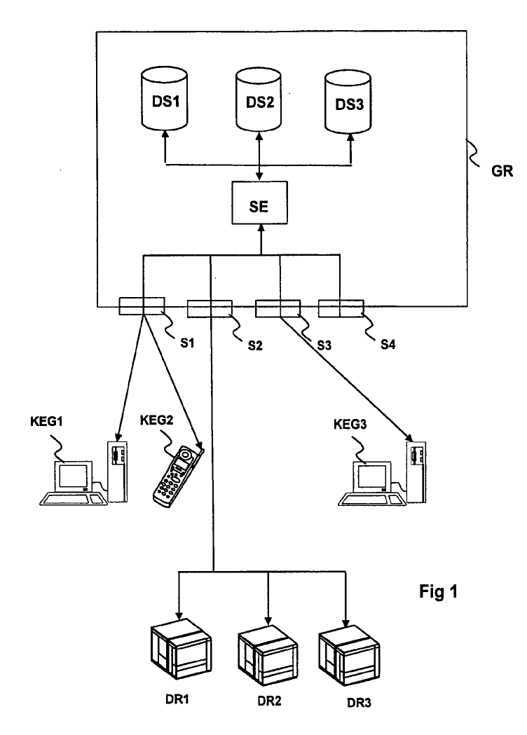

FIG. 1 shows an exemplary embodiment of a group management computer,

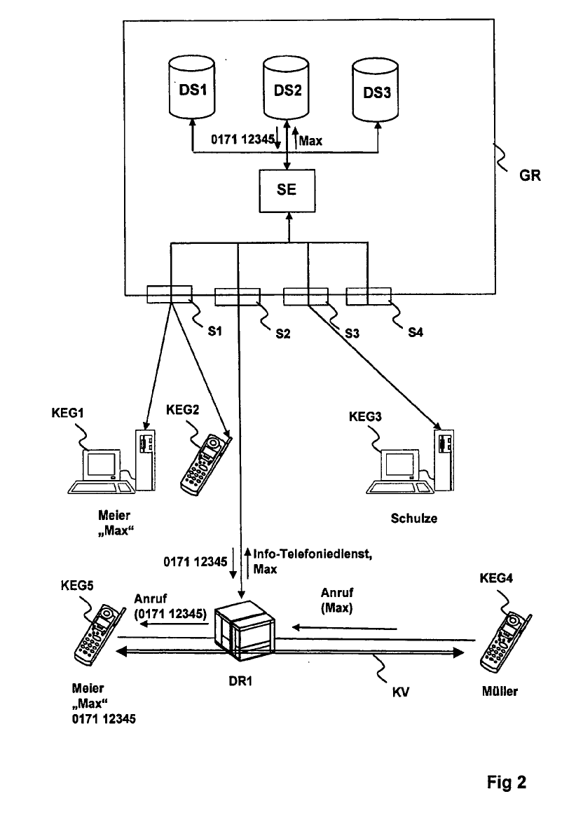

FIG. 2 shows an exemplary embodiment of the method according to the invention, and

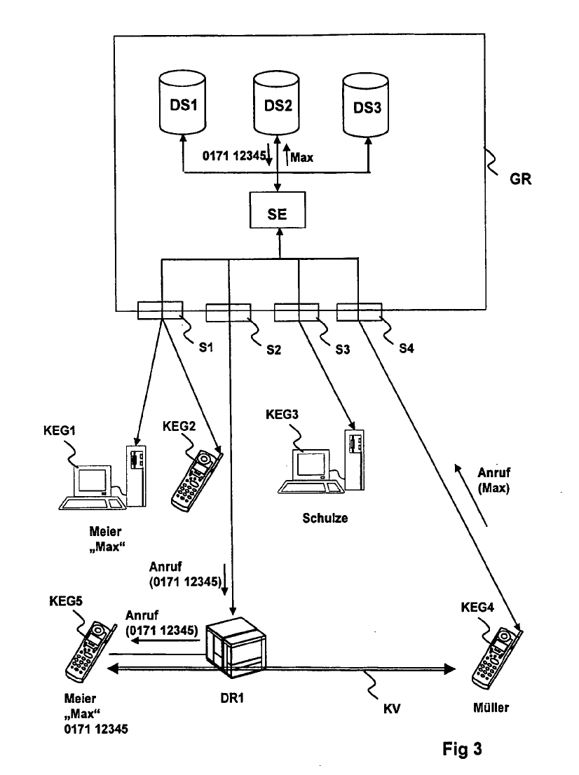

FIG. 3 shows a further exemplary embodiment of the method according to the invention.

FIG. 1 shows a group management computer GR which comprises a first data memory DS1, a second data memory DS2, a third data memory DS3, a control device SE, a first interface S1, a second interface S2, a third interface S3 and a fourth interface S4. In the exemplary embodiment, the first data memory DS1, the second data memory DS2 and the third data memory DS3 are components of the group management computer. In other exemplary embodiments, however, these data memories can also be implemented independently of the group management computer and be connected to it.

The group management computer GR (group management server) produces a group management service: the group management computer GR manages a plurality of service subscriber groups. In the following exemplary embodiments, one of these service subscriber groups is considered, namely a service subscriber group having the name “hikers”. This service subscriber group is formed by persons who jointly undertake a hiking trip and wish to use various services in conjunction with this hiking trip. The group management computer GR is connected to at least one communication network (e.g. to the Internet, a fixed telephone network and/or a mobile telephone network) which is not shown in greater detail in FIG. 1. The services are requested and/or carried out by utilizing this communication network.

A user registered with the group management service can set up and delete service subscriber groups via the third interface S3 and allocate new members to these service subscriber groups (“invite”) or remove preexisting members from the service subscriber groups. The service user registered with the group management service is often the leader of the group (group leader). The registration gives the group leader the authority to set up service subscriber groups via the third interface S3 and to invite group members into this service subscriber group, i.e. to allocate the group members to this service subscriber group. Charging for services used by the group members can be done via the registered service user. This variant has the advantage that, for example, group members from various mobile radio networks, utilizing a mobile radio communication terminal, can also participate in a group when no technical preparations or business relations exist between the mobile radio providers of these mobile radio networks and the operator of the group management service. As an alternative, however, each group member of the service subscriber group can also be registered as service user with the group management computer; in this case, the group members of the service subscriber group can also administer their person-related data via the interface S3.

Via the first interface S1, each group member of a service subscriber group can set up his own record with person-related data, fill this record with data and set up an identifier (pseudonym) for himself valid within the service subscriber group. For this purpose, the respective group member does not need to be registered with the group management service (he therefore does not need to be a user of the group management service). However, the group member of the service subscriber group must be authorized in a suitable manner. In the exemplary embodiment, this is done by the fact that the registered service user has invited the group member into the groups (i.e. allocated the group member to the group). The invitation into a group, i.e. the allocation to a group, is a prerequisite for a group member to be able to set up a record with person-related data and to fill it with data.

The first interface S1 is connected to a first communication terminal KEG1 of the group member of the service subscriber group. In the exemplary embodiment, the first communication terminal KEG is a computer of the group member of the service subscriber group. As an alternative or additionally, the first interface S1 can also be connected to a second communication terminal KEG2 of the group member of the service subscriber group. In the exemplary embodiment, the second communication terminal KEG2 is a mobile telephone of the group member of the service subscriber group.

At the first interface S1, an authentication of the group member of the service subscriber group is carried out in order to prevent unauthorized starting or changing of records with person-related data. The first interface S1 can be constructed, for example, as an Internet interface (Web interface) when the data are administered by means of an Internet computer. As an alternative or additionally, the first interface S1 can also use a communication protocol which is supported by a “user agent” installed on the communication terminal of the group member. The interface S1 can also be called a “self provisioning user interface”. The interface S1 is constructed in such a manner that it adjusts automatically to the type of person-related data to be administered and, for example, presents a suitable input mask to the group member. This will be explained further below in conjunction with “data models”. If it is intended, for example, to input data for a group service which represents an on-line payment service, an input mask is generated which enables account numbers and routing codes to be input.

Via the second interface S2, the group management computer is connected to one or more service computers (service servers) which in each case control the execution of a service. In the exemplary embodiment, the second interface S2 is connected to a first service computer DR1, to a second service computer DR2 and to a third service computer DR3. The first service computer DR1 controls the execution of a telephony service, the second service computer DR2 controls the execution of a messaging service and the third service computer DR3 controls the execution of an on-line payment service.

Via the second interface S2, the service in each case controlled by service computers DR1 to DR3 can access certain data of group members, these data having to be released for the respective service. As an alternative, the group management service can request the services controlled by the service computers DR1, DR2 or DR3 via the interface S2 and convey the data of the group members, required for the execution of these services, to the service computers.

When a service computer accesses the person-related data of group members via the second interface S2, this service computer or the service controlled by it conveys via the interface S2 the identifier of the respective group member and thereupon is sent the data needed for the execution of said service via the interface S2.

If, on the other hand, the group management service requests the service controlled by the service computer, the service computer does not receive the identifier of the service subscriber but the service computer is sent directly the data of the group member needed for the execution of the service by the group management computer.

The third interface S3 is connected to a third communication terminal KEG3 of the registered service user. Via this third communication terminal KEG3, the registered service user can set up or delete groups and invite members to these groups or remove members from these groups.

Via the fourth interface S4, group members of a service subscriber group can access the group management computer GR in order to request services which are rendered by service computers.

The first data memory DS1 is integrated in the group management computer or connected to it. The group management computer can cooperate with the most varied service computers which control the most varied services. For this reason, different data models are stored in the first data memory DS1 which are in each case adapted to a service to be controlled by a service computer. The group management service executed by the group management computer can be flexibly extended by further data models. In the data models, the structure of the person-related data is stored which are needed for the execution of the respective service. If the service is an on-line payment service, the data of the group member comprise, for example, an account number of the group member, a routing code and/or the name of the bank of the group member. In the respective data model it is then stored that an account number, a routing code and/or the name of the bank belongs to the person-related data needed for the on-line payment service. If the service is an instant messaging service, it is stored in the data model how the instant messaging identity of the group member is structured, that is to say how, e.g. the instant messaging address of the group member is structured. Data models for additional services can be newly stored subsequently at any time in the data memory (database) DS1. Thus, new services with new data models can be introduced at any time and the respective new service computers connected to the group management computer.

In the second data memory DS2, the person-related data of the group members of the service subscriber group are stored. Such data are also called “profiles”, the second data memory (database) DS2 can also be called “profile database” as a consequence. The type of the person-related data stored in the second data memory DS2 is determined or predetermined by the respective data model stored in the first data memory DS1.

In the third data memory DS3, information about the individual service subscriber groups is stored, particularly, a name of the service subscriber group and the identifiers of the group members belonging to this service subscriber group are in each case stored.

The control device SE has access both to the first data memory DS1, the second data memory DS2 and the third data memory DS3. The control device SE can write data into these data memories, read data from these data memories, process the data and control the interfaces S1 to S4.

In the text which follows, an exemplary embodiment of the method according to the invention is described by means of FIG. 2.

Mr. Schulze is a registered member of the group management service implemented by means of the group management computer GR. Before the beginning of the hiking trip, Mr. Schulze contacts the group management computer GR by means of his third communication terminal (computer) KEG3 via the third interface S3 of the group management computer GR. In doing so, Mr. Schulze specifies a group management service password which had been issued to him during his earlier registration with the group management service. Mr. Schulze sets up a new service subscriber group by the name “hikers” on the group management computer GR. Furthermore, Mr. Schulze allocates to the service subscriber group “hikers” a number of group members, among others a group member Meier and a further group member Müller. Mr. Meier and Mr. Müller are thus members of the service subscriber group “hikers”, that is to say group members. The information about the service subscriber group “hikers” and about the group members Müller and Meier of this service subscriber group are stored in the third data memory DS3.

The group member Meier is not himself registered with the group management service but because the registered group management service user Mr. Schulze has allocated the group member Meier to the service subscriber group “hikers”, Mr. Meier has the authority to store a record with his person-related data in the group management computer. For this purpose, Mr. Meier accesses the first interface S1 of the group management computer GR by means of his first communication terminal KEG1. Via this interface S1, Mr. Meier sets up a record for his own person-related data in the second data memory DS2.

Furthermore, Mr. Meier transfers via the first interface S1 the information that he would like to use a telephony service, a messaging service and an on-line payment service in conjunction with the service subscriber group “hikers” to the group management computer GR. This information is also stored in the third data memory DS3. The control device SE thereupon reads out of the first data memory DS1 the data model allocated to the telephony service. In this data model, it is stored that the telephone number of the group member is needed for the telephony service as person-related data of the group member. The control device SE thereupon generates an input mask which requests the input of the telephone number and sends this input mask to the first communication terminal KEG1 of the user Meier via the first interface S1. Mr. Meier inputs his telephone number “0171 12345” into the input mask and sends it back to the group management computer GR via the interface S1. This telephone number is stored in the record with Mr. Meier's person-related data in the second data memory DS2.

The control device SE thereupon reads out of the data model stored in the data memory DS1 and allocated to the messaging service (instant messaging service) that the instant messaging address of the group member is needed as person-related data for the instant messaging service. The control device SE generates an input mask which requests the input of the instant messaging address and sends this input mask via the first interface S1 to the first communication terminal KEG1. Mr. Meier inputs his instant messaging address into the input mask and this instant messaging address is transmitted via the first interface S1 to the second data memory DS2 and is there stored as further person-related data item of Mr. Meier in his record. Finally, the control device SE reads out of the data model stored in the first data memory DS1, which is allocated to on-line payment services, that the account number and the routing code of Mr. Meier are needed for an on-line payment service. The control device SE generates an input mask in which there are input fields for the account number and the routing code. This input mask is displayed on Mr. Meier's communication terminal KEG1. Mr. Meier inputs his account number and his routing code; the account number and the routing code are thereupon transferred via the first interface S1 to the second data memory DS2 and stored in Mr. Meier's record with his personal data.

Finally, Mr. Meier inputs on his computer KEG1 an identifier chosen by himself under which he wishes to be addressed in the service subscriber group “hikers”. This identifier must be unambiguous within the service subscriber group, i.e. each identifier may occur only once within this service subscriber group. Mr. Ronald Meier is often called “Max” by the other group members of the service subscriber group “hikers”. For this reason, Mr. Meier chooses for himself the identifier “Max” and transfers this identifier to the group management computer GR via the first interface. The identifier “Max” is stored in the third data memory DS3. Thus, the identifier “Max”, which is unambiguous within the service subscriber group “hikers”, is allocated to Mr. Meier. The person-related data input by Mr. Meier are allocated to his identifier “Max”.

Analogously, the further group member Müller inputs his person-related/personal data into the corresponding input masks by means of his communication terminal (not shown in the figure) and these data are stored as person-related data of the group member Müller in the record allocated to Mr. Müller in the second data memory DS2.

At a later point in time, Mr. Müller wishes to telephone Mr. Meier. This is intended to be done by using a telephony service which is offered by the first service computer DR1. Mr. Müller only knows Mr. Meier's identifier “Max”. Mr. Meier's telephone number is not known to Mr. Müller, however.

Mr. Müller starts to set up a communication link with his mobile radio terminal KEG4, specifying the identifier “Max” as destination of the communication. A corresponding signaling message is transferred by the mobile radio terminal KEG4 to the first service computer DR1 by means of which the telephony service controlled by the first service computer DR1 is requested/called up. Together with the identifier “Max”, the information that the identifier “Max” belongs to the service subscriber group “hikers” is transmitted to the service computer DR1 by the mobile radio terminal KG4. In this context, the designation “hikers” of the service subscriber group can be transmitted to the service computer DR1 independently of the identifier or the identifier itself can be arranged in such a manner that it carries in itself the name of the corresponding service subscriber group (an example of such an identifier would be “hikers.Max”).

The service computer DR1 thereupon sends the identifier “Max”, information about the service subscriber group and information about the requested service (in this case a code of the telephony service offered by the first service computer DR1) via the second interface S2 to the control unit SE. The control unit SE checks whether the telephony service is authorized to utilize the data of the group member having the identifier “Max”. Since the group member having the identifier “Max” (i.e. Mr. Meier) has stored in the third data memory DS3 the information that he wishes to use the telephony service within the service subscriber group “hikers” the control device SE recognizes that the telephony service is authorized for using the person-related data of Mr. Meier in as much as these data are needed for the telephony service.

From the data model for the telephony service, stored in the first data memory DS1, the control device SE reads out that the telephony service needs the telephone number of Mr. Meier to execute the service. The control device thereupon addresses Mr. Meier's record with his person-related data in the second data memory GS2 by means of the identifier “Max”. The control device SE reads out of this record Mr. Meier's telephone number 0171 12345 and sends this telephone number via the second interface S2 back to the first service computer DR1. The first service computer DR1 thereupon causes a communication link KV to be set up in the form of a telephone connection between the mobile radio terminal KEG4 of Mr. Müller and the mobile radio terminal KEG5 of Mr. Meier.

Mr. Müller is thus able to have a telephone connection to Mr. Meier set up although Mr. Müller only knows Mr. Meier's identifier “Max” but not his telephone number.

Various possibilities for generating the identifier and maintaining the person-related data associated with the identifier are conceivable. For example, a single person (in the present case a traveling group, e.g. the organizer or leader of the trip) can maintain registration (subscription) with the group management service. This registration gives them the right to set up identifiers, grant access authorizations for these identifiers (e.g. PIN numbers, passwords) and then to distribute these identifiers and access authorizations to those persons who are intended to be group members of the service subscriber group (the fellow travelers in the exemplary embodiment). The fellow travelers can then enter their person-associated data independently into the group management computer. The organizer or leader of the trip would not be able to look into the person-associated or person-related data of the group members in this case.

In an alternative variant, however, each potential group member can be registered or register himself with the group management service and then authenticate himself to the group management service on the basis of this registration. Each group member can then connect his profile, which may be already in existence (record with person-related data) with the identifier desired by him without having to reenter his person-related data every time. In this context, it would be necessary that all subscribers of the service subscriber group have a registration with the group management computer/group management service. If this is difficult to implement, the method can also be expanded in such a way that the group members do not necessarily have to have a registration at one and the same group management computer. It is also possible for group management services and group management computers of various providers to be connected to one another and communicate in such a manner that there is a trust relationship between the services and computers, respectively. A group management service could then forward person-related data of its group members to another group management service, ensuring that this other group management service also applies the required policies for handling person-related data.

FIG. 3 shows a further sequence of the method. With respect to setting up the service subscriber group “hikers” via the third interface S3 and inputting the person-related data via the first interface S1, this method corresponds to the method described in conjunction with FIG. 2. In this method, too, Mr. Müller wishes to call the group member having the identifier “Max” by means of his mobile radio terminal KEG4. In this exemplary embodiment, however, a signaling message is sent from the mobile radio terminal KEG4 to the group management computer GR via the fourth interface S4. The signaling message contains the identifier “Max”, and information about the fact that the identifier “Max” belongs to the service subscriber “hikers” and information that a telephony service is to be requested/called up in order to set up a communication link to the group member having the identifier “Max”.

The group management computer GR checks whether a telephony service is authorized to access the person-related data of the group member “Max”. This is the case in this exemplary embodiment, too. Furthermore, the group management computer GR selects from the multiplicity of service computers (DR1, DR2, DR3) the service computer which controls a telephony service. The selection is made in dependence on the service requested, particularly by means of the information about the type of requested service. In the exemplary embodiment, the requested telephony service is implemented or controlled, respectively, by the first service computer DR1. The memory device SE thereupon reads out the telephone number of the group member “Max” from the record allocated to the group member having the identifier “Max”, and sends this telephone number to the first service computer DR1 via the second interface S2. Together with the telephone number of Mr. Meier, an information item is transmitted to the first service computer DR1 which has the content that Mr. Müller wishes to set up the telephony connection to Mr. Meier. This information can consist, for example, in that the telephone number of Mr. Müller is transferred to the service computer DR1. The first service computer DR1 thereupon sets up a communication link between the mobile radio terminal KEG4 and the mobile radio terminal KEG5 of Mr. Meier.

Communication between the group management computer GR and the service computer DR1 can take place, for example, by means of the Application Programming Interface (API) “OSA” developed as part of the Third Generation Partnership Project 3GPP, using especially the “call control” methods.

Compared with the method shown in connection with FIG. 2, this method has the advantage that the service computer DR1 (i.e. in the case of the service requested and to be executed) only knows the directory number of Mr. Meier but not his identifier “Max”. Thus, the information that the telephone number 0171 12345 belongs to the group member having the identifier “Max” of the service subscriber group “hikers” remains hidden from the telephony service. The allocation of the group member “Max” of the service subscriber group “hikers” to the person-related telephone number 0171 12345 thus did not become known outside the group management computer GR. This results in a particularly secure method.

Hitherto, exemplary embodiments of the method according to the invention with a telephony service have been described. However, the telephony service should be considered to be only one example. Almost any services can be utilized in the method according to the invention and the group management computer according to the invention. For example, the method according to the invention can also proceed in conjunction with a messaging service (e.g. an instant messaging service). In this case, Mr. Müller may want to send an instant message to Mr. Meier. Mr. Müller addresses this instant message with the identifier “Max” and the group “hikers” and sends this instant message to the instant messaging service which is controlled by the service computer DR2. The service computer DR2 thereupon enquires from the group management computer GR what the instant messaging address of group member “Max” from the group “hikers” is. The group management computer GR checks whether the instant messaging service is authorized to use the instant messaging address of the group member “Max” of the service subscriber group “hikers”. This is so because group member “Max” has specified that he would like to use the messaging service within the group “hikers”. The group management computer GR thereupon sends the instant messaging address of “Max” back to the second service computer DR2. This enables the second service computer DR2 to deliver the instant messaging message received from the mobile radio terminal KEG4 to the mobile radio terminal KEG5 of Mr. Meier (“Max”). This assumes that the instant messaging address is allocated to the mobile radio terminal KEG5 of Mr. Meier.

In a further exemplary embodiment, Mr. Müller wishes to transfer money to Mr. Meier because Mr. Meier has procured a theatre ticket for Mr. Müller. Mr. Müller instructs the on-line payment service controlled by the service computer DR3 by means of his communication terminal KEG4 to transfer a certain sum of money to the group member “Max” of the “hikers”. Mr. Müller thus requests the on-line payment service. The third service computer DR3 thereupon requests the person-related data of the group member “Max, hikers”, relating to the on-line payment service, from the group management computer GR. The group management computer GR checks again whether the third service computer DR3 is authorized to access these data of the group member “Max”. This is so and the group management computer GR reads out the account number and the routing code from the second data memory DS2 and conveys these to the third service computer DR3 via the second interface S2. The third service computer DR3 thereupon transfers the money.

At the end of the hiking trip, Mr. Meier wishes to break off contact to the other group members of the service subscriber group “hikers”, i.e. he no longer wishes to be available to these, he wishes to be no longer available via services requested by these. Mr. Meier therefore accesses the group management computer GR via the interface S1 via his communication terminal KEG1. Mr. Meier deletes his identifier “Max” which is allocated to the service subscriber group “hikers”. Following this, Mr. Meier can no longer be reached by the identifier “Max”, i.e. future telephone calls, messages or transfers of money which are addressed with the identifier “Max” cannot be carried out or transferred. If in future, a service is requested, the execution of which requires the data of the former group member “Max”, the group management computer GR determines that no group member having an identifier “Max” is allocated to the group “hikers”. The requested service is thereupon informed correspondingly with an error message.

However, the person-related data of Mr. Meier remain stored in his record in the second data memory DS2, i.e. they are retained for future service subscriber group memberships. If Mr. Meier becomes member of another service subscriber group (or even the same service subscriber group) at a later time, it is not necessary to reenter his personal data. Mr. Meier can thus restrict access to his person-related data by simply deleting his identifier “Max” and later cancel this restriction again by allocating a new identifier. The identifier “Max” can therefore also be called a temporary pseudonym.

Naturally, as an alternative, the service subscriber group “hikers” can also be deleted completely after the end of the hiking trip if this is wished by all group members of the service subscriber group. The identifiers of all group members of the service subscriber group “hikers” are then no longer stored at the group management computer GR so that in future, no services can be carried out for these group members with respect to this service subscriber group.

A method and a group management computer have been described in which group members of a service subscriber group are referenced (addressed) by other group members of this service subscriber group by means of an identifier (pseudonym). This identifier is valid and visible only within the service subscriber group, i.e. the identifier can only be used by members of the service subscriber group. The storage of person-related data of the group members is integrated in the group management service. The group management service forwards these person-related data only to authorized other services, but not to the other group members of this group. The person-related data of a particular group member thus remain hidden from the other group members of the group and cannot be viewed directly by these. Nevertheless, the other group members can request and use services, the execution of which requires the data of the group member, by specifying the identifier of the group member when requesting such a service. By means of this identifier, the person-related data needed for the execution of the service are addressed in the group management computer. From the totality of available person-related data of the group member, the data needed for the execution of the service can then be selected (filtered out).

Thus, the person-related data are protected and access to these person-related data is restricted. For example, a group member who requests a service, for the execution of which the data of another group member are needed, does not receive the person-related data of this other group member. The person-related data of the other group member are only conveyed to the corresponding service or service computer which controls the requested service. Each group member can control the access to his person-related data, e.g. by deleting his identifier and possibly newly installing another identifier. This deletion and possibly new installation of another identifier can occur by interaction between group member and service management computer or even under time control. Each group member can also restrict the access to his person-related data by correspondingly changing the data associated with his identifier. For example, each group member can change the selection of the services which the group member wishes to utilize with respect to his service subscriber group. The operator of the group management service guarantees the correct use of the person-related data in accordance with a policy agreed with the individual group members.

The method described and the computer described have a number of advantages. Setting up and managing service subscriber groups is done in a simple manner, the service subscriber groups can be used in conjunction with the most varied services to be requested. The group management service can be offered for subscribers of different communication networks without the group management service needing to be known in the various communication networks and without all group members having to be registered with the group management service. The group members only need to be allocated to a service subscriber group (invitation) by a registered entity/person.

By means of the data models present in the first data memory DS1, the group management service can be coupled to/interact with the most varied services. The structure of person-related data can be expanded almost arbitrarily even in the case of a preexisting group management service by accommodating new data models. As a result, the group management service can be coupled, e.g. to almost any communication services without the services having to be known already in the original implementation of the group management service.

The individual group members of the service subscriber group can control the use of their person-related data or restrict the access to these data, respectively, in a simple and comfortable manner. This can be done, e.g. by deleting their identifier or by changing the data associated with (allocated to) the identifier. Furthermore, the group members can select the services which can access the person-related data via a particular identifier.

The group management service or the identifiers used in it, respectively, and the data allocated to these identifiers can be used flexibly by almost any other services (e.g. telephony services, instant messaging services, push-to-talk services, E-mail services, money transfer services etc.).

1. A method for restricting the access to data of group members of a service subscriber group, in which
an identifier is in each case allocated to group members of a service subscriber group,
the data of the group members are in each case allocated to the identifier, and
the data of the group members are stored in a data memory (DS2) of a group management computer (GR) which manages the service subscriber group, wherein, in the method,
a first group member, specifying the identifier of a second group member, requests a service, the execution of which requires the data of the second group member,
the identifier of the second group member is transmitted to the group management computer (GR),
a check is made whether the requested service is authorized to utilize the data of the second group member,
when an authorization is present, the data of the second group member are transferred to a service computer (DR1) controlling the execution of the requested service, whereupon the service can be executed by utilizing the data.

2. The method as claimed in claim 1, characterized in that
the service subscriber group is set up for utilizing several different services.

3. The method as claimed in claim 1, characterized in that
from the data of the second group member, those data are selected which are needed for executing the requested service, and
the selected data are transferred to the service computer (DR1).

4. The method as claimed in claim 1, characterized in that
from a multiplicity of service computers (DR1, DR2, DR3), the service computer (DR1) controlling the requested service is selected, and
the data of the second group member are transferred to the selected service computer (DR1).

5. The method as claimed in claim 1, characterized in that
a telephony service, a messaging service or an on-line payment service is requested as service.

6. The method as claimed in claim 5, characterized in that
in the case of a telephony service, the data of the second group member comprise a telephone number of the second group member,
in the case of a messaging service, the data of the second group member comprise a message address of the second group member, or
in the case of an on-line payment service, the data of the second group member comprise an account number of the second group member.

7. The method as claimed in claim 1, characterized in that
the data of the second group member are kept available by the group management computer (GR) in such a manner that various service-controlling service computers (DR1, DR2, DR3) can access the data and/or that the data can be transferred to various service-controlling service computers (DR1, DR2, DR3).

8. A group management computer (GR), which is arranged for
receiving (S2, S4) an identifier of a group member of a service subscriber group,
for receiving (S2, S4) information about a service for the execution of which data of the group member are needed,
for checking whether the service is authorized to use the data of the group member, and
for transmitting (S2) the data of the group member to a service computer (DR1) controlling the execution of the service.

9. The group management computer as claimed in claim 8, characterized in that it is arranged for
selecting those data from the data of the group member which are needed for executing the service, and
for transferring the selected data to the service computer (DR1).

10. The group management computer as claimed in claim 8, characterized in that it is arranged for
selecting a service computer from a multiplicity of service computers (DR1, DR2, DR3) by means of the received information about the service, and
for transferring the data to the selected service computer (DR1).

11. The group management computer as claimed in claim 8, characterized in that it is arranged for
transferring a telephone number of the group member to the service computer (DR1) controlling the execution of the service if the service is a telephony service,
transferring a message address of the group member to the service computer (DR2) controlling the execution of the service if the service is a messaging service, and/or
transferring an account number of the group member to the service computer (DR3) controlling the execution of the service if the service is an on-line payment service.

12. The group management computer as claimed in claim 8, characterized in that it is arranged for
enabling various service-controlling service computers (DR1, DR2, DR3) to access the data of the group member and/or
transferring the data of the group member to various service-controlling service computers (DR1, DR2, DR3).

13. The group management computer as claimed in claim 8, characterized in that it has an interface (S3) for setting up, changing and/or deleting service subscriber groups.

14. The group management computer as claimed in claim 8, characterized in that it has an interface (S1, S3) for inputting, changing and/or deleting identifiers of group members.

15. The group management computer as claimed in claim 8, characterized in that it has an interface (S1, S3) for inputting, changing and/or deleting data of group members.

16. The group management computer as claimed in claim 8, characterized in that it has an interface (S2) for communicating with at least one service-controlling service computer (DR1, DR2, DR3).
